(19) United States
(12) Patent Application Publication
(10) Pub. No.: US 2007/0282719 A1
(43) Pub. Date: Dec. 6, 2007

(54) PLATFORM GENERATOR FOR PROCESSING FINANCIAL ACTIVITIES AND MANAGEMENT THEREOF

(76) Inventors: Haim ZEMAH, Or-Yehuda (IL); Jacob Katz, Or-Yehuda (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/741,023

(22) Filed: Apr. 27, 2007

Related U.S. Application Data
(60) Provisional application No. 60/795,163, filed on Apr. 27, 2006.

(51) Int. Cl. G06Q 40/00; G06F 19/00

(52) U.S. Cl. 705/30

(57) ABSTRACT

The present invention discloses a software platform generator for processing and managing financial activities in financial organizations. The present invention enables financial experts build their own computer aided tool for processing and managing financial activities. The platform generator includes an interactive software builder that enables financial experts define their system requirements in their own terminology. The software builder then ‘translates’ the financial terminology based system and generates a computer code executable over the financial organization's network.

### CROSS-REFERENCE TO RELATED APPLICATIONS

This application claims the benefit under 35 U.S.C. § 119(c) of U.S. Provisional Patent Application No. 60/795,163 filed Apr. 27, 2006, the content of which is incorporated by reference herein.

### FIELD OF THE INVENTION

The present invention relates to computer aided tools for the financial services sector and more particularly to a software platform generator that enables processing and managing financial activities

### BACKGROUND OF THE INVENTION

The financial services sector today is characterizes in a never-ending process of introducing new computerized products and services to the market. These computerized products and services are usually a co-production of financial experts and IT experts. Currently, the development flow of a new computerized product or service is as follows: first, the financial experts are defining the new system requirements; then the financial experts are describing the new system requirements to the IT experts who in turn transform these requirements into an executable programming language code and working software. The new software is then functionally tested by the financial experts and revisions in the software are made by the IT experts according to the financial experts' comments.

The main problem of the above mentioned development flow is that IT experts are usually not familiar with financial terminology and accounting jargon. On the other hand, financial experts usually lack the technological understanding required to develop on their own a computerized financial product or service.

Several attempts have been made, with partial success only, to address the IT—finance communication gap. For example, US Patent Application No. US2005154659, which is incorporated by reference in its entirety herein, discloses a unique versatile executor engine which can interpret and execute transaction structures and information views to build information systems.

### SUMMARY OF THE INVENTION

The present invention solves the communication gap between financial experts and IT experts. It discloses a customer-tailored platform generator for processing and managing financial activities for financial organizations. The platform includes an interactive software builder that enables financial experts define their system requirements in their own accounting and financial terminology. The software builder then ‘translates’ the financial and accounting terminology based system and generates a computer code executable over the financial organization's network.

According to some embodiments of the invention, by being both general purpose and modular, the platform is capable of supporting any financial activity defined by the organization either online or offline. It thus provides a comprehensive solution with high levels of system integration.

According to the some embodiments of the invention, the platform generator includes two main components:

(1) Financial Products Engine (FPE)—a user-friendly software builder functioned to receive instructions and definitions in financial terminology and generate, in turn, a computer language code executable over the OPP. Preferably, the FPE is functioned to enable financial experts design their own financial products or services with minimal or no assistance from IT experts.

(2) An online processing platform (OPP)—a platform comprising of a script driven generic state machine that is capable of tailoring multiple online resources into an online unified transaction processing platform. In particular, this generic platform is capable of handling all incoming and outgoing online requests to/from various payment networks. Preferably, the OPP is designed to function under unstable environment conditions such as: non deterministic processes, unexpected events in terms of resources availability and unpredicted response time.

### BRIEF DESCRIPTION OF DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 is a schematic block diagram showing the architecture of the invention;

FIG. 2 shows the Accounts table according some aspects of the present invention;

FIG. 3 shows the Agreements table according some aspects of the present invention;

FIG. 4 shows the Products table according some aspects of the present invention;

FIG. 5 shows the Transactions table according some aspects of the present invention;

FIG. 6 shows the general ledger (GL) Activities table according some aspects of the present invention;

FIG. 7 shows the Activity Types table according some aspects of the present invention;

FIG. 8 shows the Activity Scripts according some aspects of the present invention;

FIG. 9 is a flowchart showing the operation of the invention;

FIG. 10 is a flowchart showing in further details the operation of the present invention in relation to the tables architecture;

FIG. 11 is a schematic block diagram showing in further details the structure of the Online Processing platform (OPP) according to the present invention.

The drawings together with the description make apparent to those skilled in the art how the invention may be embodied in practice.

Further, where considered appropriate, reference numerals may be repeated among the figures to indicate corresponding or analogous elements. note: no mechanical drawings here

### DETAILED DESCRIPTION OF THE INVENTION

The present invention discloses a software platform generator for financial activities of financial organizations. The present invention comprises a Financial Products Engine (FPE) and an Online Processing Platform (OPP).

According to all embodiments of this invention the FPE is a user-friendly software builder, functioned to receive financial system specifications and relevant financial rules both in financial terminology and generate a computer language code encapsulating said financial system specifications. The code generated is executable over the OPP which is a general purpose platform comprising of a script driven generic state machine that is capable of tailoring multiple online resources into an online unified transaction processing platform. In particular, this generic platform is capable of handling all incoming and outgoing online requests to/from various payment networks.

Advantageously, the use of the invention minimizes the dependency upon IT experts in launching a new financial product or service. Thus, the present invention shortens time-to-market for new products and test pilots. Similarly, the present invention will shorten the development time of new revisions of financial system generated by the FPE. A change of the predefined financial rules for example, will automatically update and modify the financial system accordingly.

According to all embodiments of the invention any financial system generated by the FPE is bound to be balanced from an accounting point of view. This feature derives from the fast that any financial activity is generated in the FPE in a double bookkeeping format. The double bookkeeping is achieved by updating simultaneously and preferably online, the relevant databases in regards to the relevant financial activities, financial instructions, financial transactions and definitions.

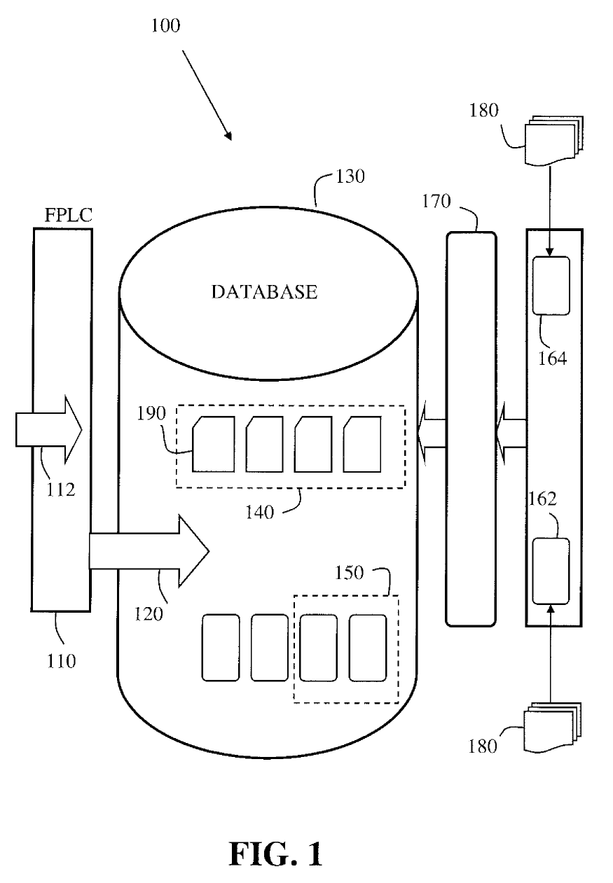

FIG. 1 is a schematic block diagram showing the general architecture of the invention is depicted in the form of a block diagram. The Platform Generator 100 is comprised of a Financial Products Language Compiler (FPLC) 110 which is functioned to receive accounting-language oriented instructions 112 and generate in turn Billing Processes 120. The Billing Processes 120 are stored on a networked database 130, in the form of stored procedures 140. The Financial Products 150 are essentially combinations of at least one stored procedure 140 and are therefore also stored on the database 130. The database 130 is connected to a Billing Service Module 160 via an interface 170. The Billing Service Module 160 is functioned to receive Transaction Files 180 through the Batch Management Module 162. In addition, the Billing Service Module 160 is functioned to receive Transaction Files 180 via the Online Management Module 164. The operation of the Platform Generator 100 is as follows: whenever a Transaction File 180 is entered to the Platform Generator 100, either via the Online Management Module 164 or via the Batch Management Module 162, it is allocated to the relevant Financial Product 150 and is subsequently processed. If applicable, the Platform Generator 100 creates outgoing records to be sent to external systems.

According to the preferred embodiment of the invention, the FPE user-interface utilizes a dedicated accounting-oriented language called Product Development Language (PDL). The PDL is a dedicated user friendly programming language used to instruct to the FPLC 112 how a billing scheme looks like using an Accounting terminology (basically, it generates a general ledger (GL) record). Preferably, the PDL does not have to be a language with its own syntax and compiler and may also be implemented as an adds-on or merely as a collection of objects being used with a traditional programming language compiled or interpreted with one of the standard tools available in the market. The PDL adheres to the following concepts:
1. It must support creating a set of Debit/Credit GL activities into the GL Activities table.
2. It must provide tools for the non-programmer so that he or she can easily use source objects and target objects with no special programming knowledge.
3. It must provide the following basic functionality: Target GL Activity Record fields are populated using some manipulation on Source Objects (Accounts, Agreements, Products, etc.) fields.

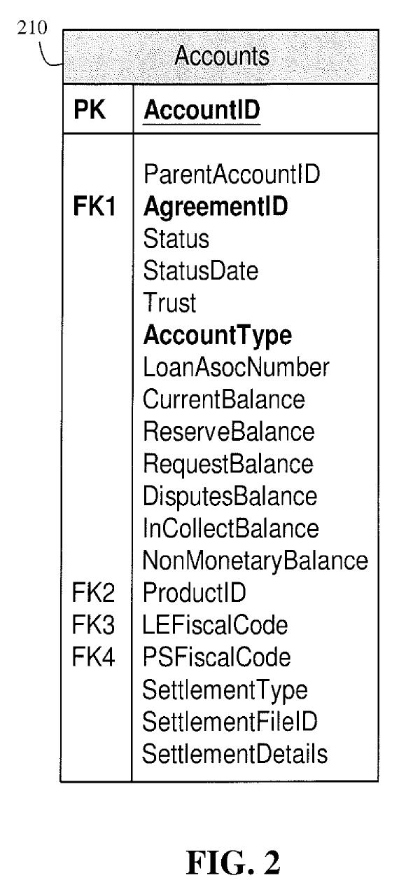

In accordance with another fundamental aspect of the invention, any stored procedure 140 utilizes a special tables architecture. According to this tables architecture specific aspects of the financial activities are predefined and are used for a thorough classification of said financial activities. Following is a detailed example of this unique tables architecture, referring to FIGS. 2-8:

FIG. 2 is an example for the Accounts table 210. According to this aspect of the invention, every entity capable of participating in a transaction is considered as a business entity thus can have an account record in the Accounts table 210. The Accounts table 210 holds the records that represent the different business entities processed in the system (companies, private people, families, organizations, clubs, etc.).

Accounts may also be organized in hierarchies. To build an hierarchy each ‘child’ account must specify who is its parent account, thus by specifying in some accounts that they have parent accounts hierarchies trees of accounts may be built with endless branches and unlimited depth.

Each account can participate in a business transaction directly (explicitly specified on the transaction record) or indirectly (specified by one of the activities that are derived from a transaction). An account may have several Balances, but only one is the Current Balance that actually shows what is the actual amount needed to be Credited or Debited to/from the Account owner through his physical Settlement account (the account owner may be debited/credited through his bank account, by requesting him to send a check.

The Account ID field in the Accounts table specifies a unique, internal identifier to the account, regardless of its identification in other sub systems or external systems.

Once an account is closed, its status is being changed to ‘Closed’, but the record itself is not deleted (ever) because history must be kept attached to this account. The Balances shown in FIG. 2 are implemented directly in the Account record itself; however, in reality the Balances are external to the Accounts table 200 and only point to it. This way Balances can be added freely to the account, and they can be generated ‘on the fly’ once they are being used. This way, if a transaction makes use of a certain balance name and it is still not part of the account structure, it can be added immediately to the account and on the same time updated with the proper value. This ‘dynamic’ behavior of balances is crucial for ease of use because the billing scheme designer does not have to setup new balances prior to the first execution of a new product. Instead, once the product is defined and new transactions start to hit the system, the balances are being created automatically during the daily run.

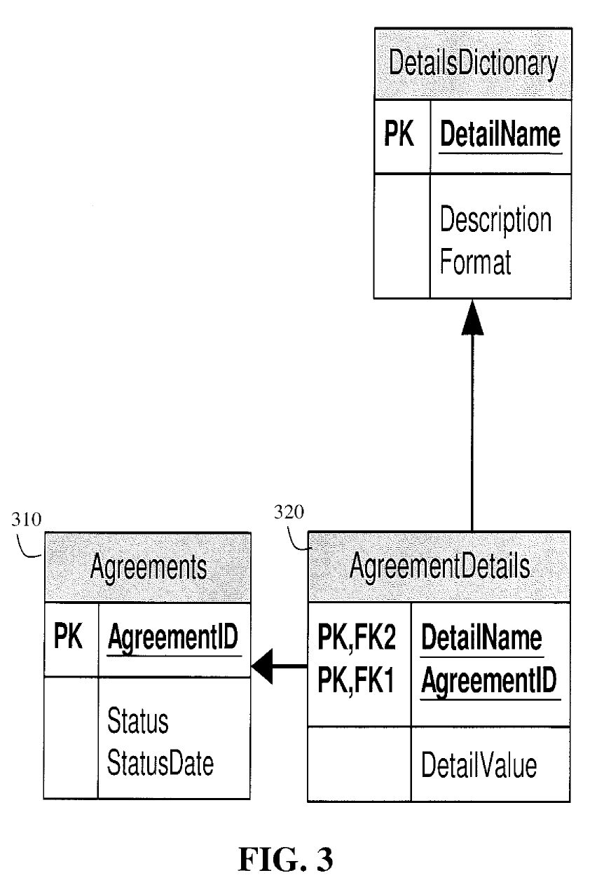

FIG. 3 is an example for the Agreements table 310. Each account has an agreement attached to it. This Agreement specifies all the business details that were agreed upon when the account owner joined the system. An account can only have one Agreement attached, however the same Agreement may apply to several accounts (e.g. A standard Gold Visa Card may apply to all Gold Visa Cardholders), Thus, if the same agreement applies to several accounts, with no changes, they will all point to this agreement. If, however, there are accounts with some differences (even small variances), a separate Agreement record will be opened for them and all relevant details will be copied or generated under this agreement. Another way to implement it is to have Agreement Details table 320 attached to each account 1 product/product type record and have them all join together into s single agreement of the account once a transaction is performed against the account—this way more sophisticated agreements can be described including templates, inheritance, etc. Since different Account Types may have totally different Agreement Details 320 (e.g. a Gold Visa Cardholder agreement details are not the same as a Chain store Merchant agreement details), the agreement record itself is only a pointer to a set of variables (held in the Agreement Details table 320) that are specific to the agreement they belong to and probably to the account it is attached to. It should be noted that the figures in the description only show the simple way by which agreement details can be attached to various entities within the database.

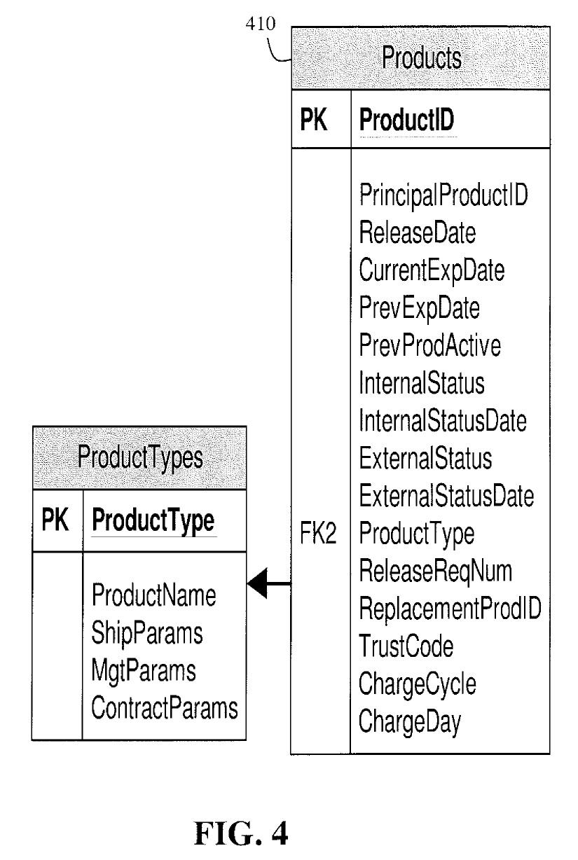

FIG. 4 shows an example for the Products Table 410. An Account owner may have a Product attached. This is the actual commercial product that was sold to it by the processing bank. Whether it is a Gold visa card, a Classic MasterCard card, a Point of sale, or any other product relevant to the industry, it appears on this Products table, attached to its owner account.

The simplest form of Account-Product relationship is a cardholder or a merchant with no parent accounts or multiple products, thus a single Account has a single Product attached to it (appears as a ProductID foreign key on the Accounts record). This is a simple cardholder or a simple merchant. In the illustration there cannot be more than a single product per account, however, another architecture, which is better and is used in reality is one that an account has more than one financial product. Thus, multiple products can be attached to a single account, or each product to another account and each one of them has the same parent, and so forth—these are all schemes that can be described. In the case of multiple products per single account it should be decided if the person wants to be debited in a single charge (combined statement) thus only the parent account has charge information set while the child accounts do not have any charge details, or each card is to be handled separately thus each card has charge details updated on it while the parent account charge details are empty.

An important feature of the Products record is its ability to handle ‘replacement’ products on a single record. It is common in the credit cards industry that a replacement card is issued to the cardholder either because the old one has expired or because it was lost/stolen. If the old card expired there is a time slot in which both cards are active (the old one was not collected from the cardholder yet, and the new one was not activated yet). During this ‘parallel’ period the same card number (Product ID) applies to two plastics. For that reason the record has a Previous Expiration Date and a Current Expiration Date. This way both cards exist on a single product record and as long as the Previous Product is still Active both cards are accepted. Another option is to have two different product records attached to the same account, one is old and another one is new.

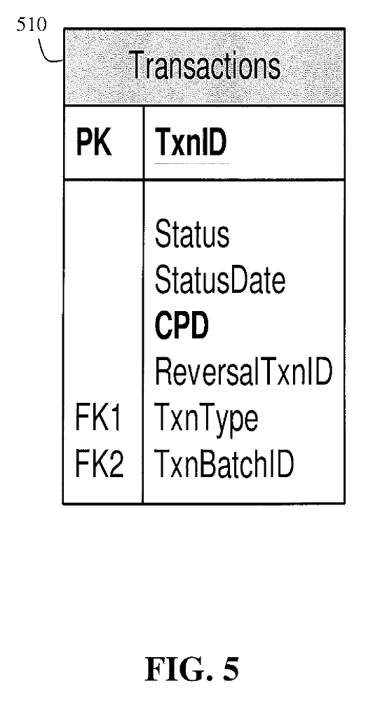

FIG. 5 shows an example for the Transactions table Sit). All the dynamic activity is fed into the billing system as transactions. No data is allowed to enter the system directly into one of the tables. If there is an undefined billing process it should first be defined as a new transaction type and then the rules of breaking this new transaction into financial activities should be configured. As soon as a transaction enters the Transactions table 510 it is broken into activities.

Each transaction belongs to a Batch (identified by a Batch ID). A Batch is used to separate between the transactions that are going to be processed at the end of the day and the transactions that enter the system after the day was closed. Each time a day is closed a new Batch record is generated and all new transactions enter with the new Batch ID.

If a transaction reverses another transaction that previously entered the system, both transactions contain each other's transaction ID thus it is easy to cross-reference between the original and its reversal.

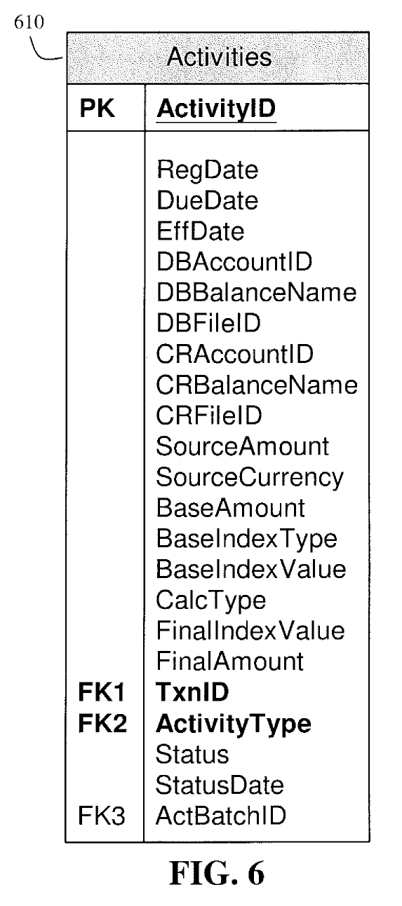

FIG. 6 shows an example for the GL Activities Table 610. Each transaction entering the system is broken into ‘atomic’ financial activities. Those activities have two purposes; one is to register the financial activity exactly like it would be done in a GL system, and the other is to technically generate the records required to interface with external systems and actually move funds from one account to another on their due dates.

Each activity is uniquely identified by its Activity ID and is related to the Transaction that generated it. When the activities enter the table for the first time their Registration Date is stored. In parallel two other dates are calculated; one is the activity's Due Date, which technically marks for the billing engine when its time to execute the activity and the second is the Effective Date, which mark the date according to which financial calculations must be done.

Each activity has influence on two accounts: the account that is Debited and the account that is Credited. This means that each activity moves an Amount from one account to the other, and that is the essence of the entire billing system. All it does is to move the funds from one account to another on a given date.

Not only the amounts are moved from one account to another (from the debited account to the credited account), but also from a specific Balance in the accounts. This is required for handling sophisticated business models however the most useful Balance is the Current Balance. The Current Balance field on each account is the main balance through which funds are transferred. Nevertheless, amounts may be transferred between other balances as well, thus it is necessary to state on the activity not only the account ID but also the balance name.

Sometimes an activity has to affect the ‘real world’ thus generate some physical record for an interface file. (e.g. create a record to the bank, send a message via SMS, etc.) Although it does not part of the billing process and has no financial effect this feature is useful for interface records that should be triggered upon an execution of an activity. For this reason, on each activity record there are two File ID fields. When the activity is being executed, if there is a value in one or both of these fields a tag record is written in the appropriate file (a table that represents files) and later it is converted into a real interface record. Another implementation can be to generate Events instead of File Records, thus any even type can be generated from the billing system that can start any external process.

Each activity describes which account should be debited, which account should be credited, on what date and for how much... However, not always the final amount is known at the moment of activity generation (activities may be executed in the future and thus the final amount depends on foreign currencies, indexes, interest calculations, etc.). For that reason each activity contains the source amount in the original currency in which the transaction was generated, the base amount (in local currency) by which financial calculations should be made and the final amount, which actually affects the account's balance on the due date. This final amount field is calculated only on the activity's due date.

Each activity is executed within a Batch (Act Batch). This batch is required to be able to roll back the effect on account balances in case the system crashes in the middle of the daily run.

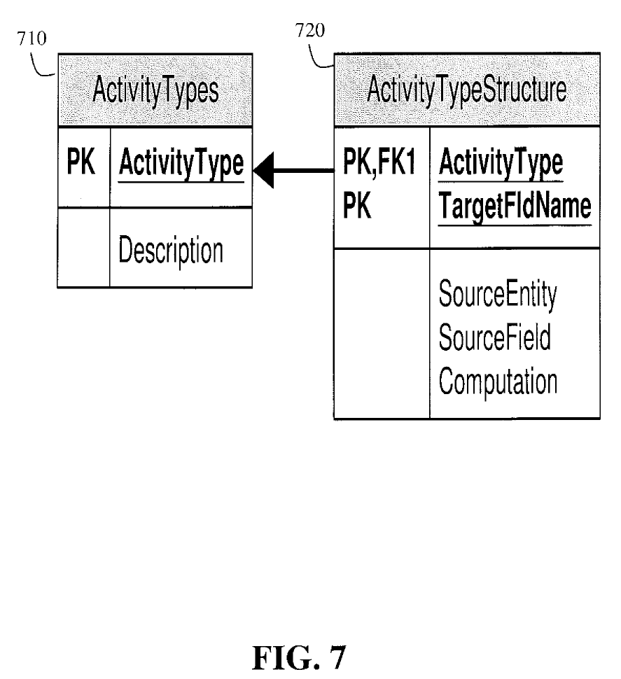

FIG. 7 shows an example for the Activity Types table 710. Activities that are put in the Activities table 710 are selected from the list of Activity Types. Each activity type serves a specific purpose, and if the product designer cannot find an activity type that meets his needs he can create a new activity type and specify its details.

It is essential that an activity's type appear in the Activity Types table 710 for the following reasons:
1. To prevent ‘free style’ activities from appearing in the system without financial people control.
2. To be able to generate activities automatically from a transaction just by specifying their types.
3. To allow automatic processes to understand the meaning of each activity if it is required.

Basically the task confronted by an activity designer is to populate the activity's fields with the required values. This is done according to the specifications in the Activity Type Structure table 720. The structure of an activity is described as follows:
1. Target Field Name specifies to which field in the Activity record the value should be written.
2. Source Entity specifies where the data should be taken from; The Transaction record; The Agreement of the debited party; The Agreement of the credited party; Basically source entity means—from what table the data should be taken
3. Source Field specifies which field on the source entity contains the required value.
4. Computation is the name of a stored function that given the source object name and the source object field can now calculate the value that should be put on the target field. (e.g. if target field is DueDate, Source Entity is Cardholder, Source Field is Cycle Day, and Computation is “NextCycleBusinessDate”, the date that will be put on the Activity Due Date field will be calculated by the function NextCycleBusinessDate that takes as parameters the cycle day of the cardholder.)

If the Source Entity and Source Field are left empty that means that the function does not take any parameters and returns a value based on its internal logic.

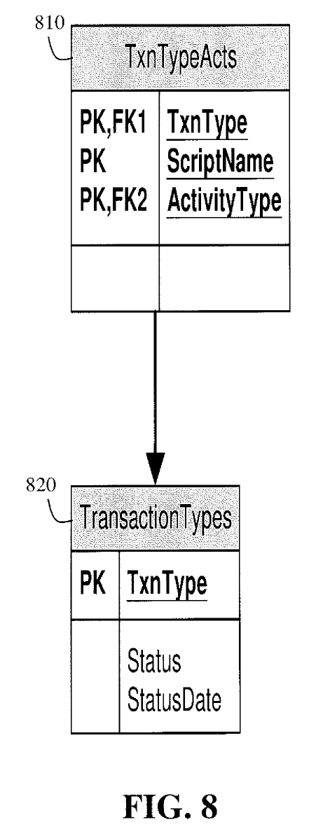

FIG. 8 shows an example for the Activity Scripts table 810. Each Transaction Type 820 is broken into a list of Activities, which reside on the Activity Types table. Since there may be some variation to a specific Transaction Type, and to reduce the number of Transaction Types, the linking of activity types to a specific transaction type can have an extra identifier that is the Script Name. This allows for the same transaction type to have several break scripts.

When a transaction enters the Transactions table the first action is to trigger a routine that breaks the transaction into activities. According to some information on the transaction the code can also select the exact script by which the list of activity types will be selected.

An alternative to this mechanism is to create a new transaction type for each variation of the transaction and to name it differently. Both methods are good however the second one is less maintainable.

In general, the activity scripts explain to the system how the billing scheme looks like in accounting terminology.

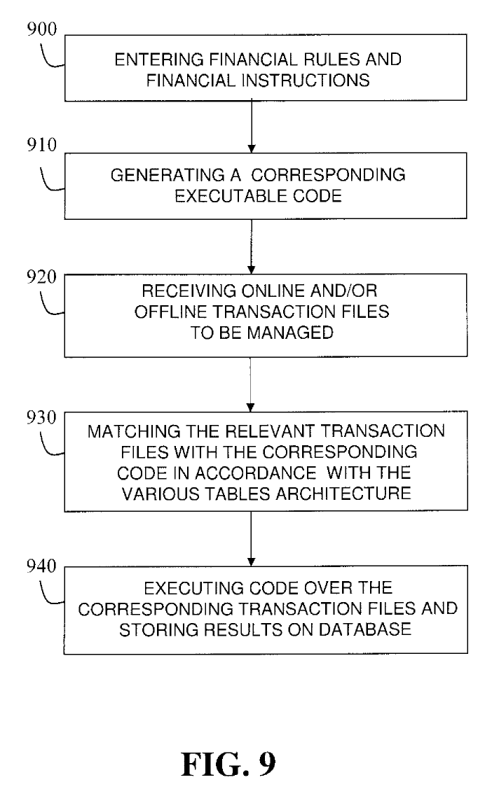

FIG. 9 is a flowchart showing the overall sequence of operation of the invention. First, the user enters financial rules and financial instructions in Financial Products Development Language (PDL) 900, as a result, the FPE 102, generates an executable code Financial Products 150 and store it on the database 130, 910; Subsequently, the OPP 104 is receiving online and/or offline transaction files to be managed 920; Then the OPP matches the relevant transaction files 180 with the corresponding Financial Products 140 in accordance with the various tables 930; Finally the relevant financial products are executed over the corresponding transaction files and results are store on database 130, 940.

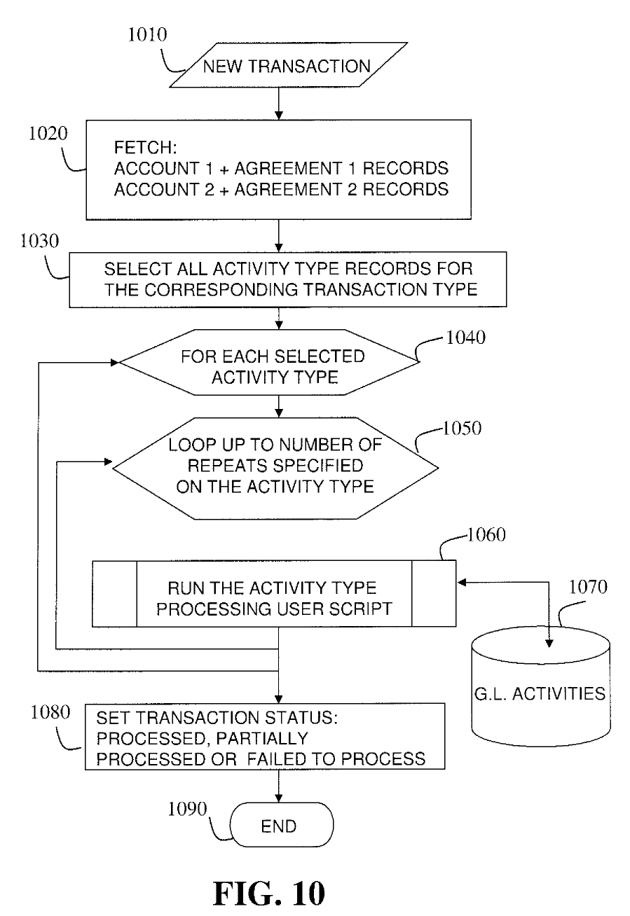

FIG. 10 is a flowchart showing in further details the operation of the invention in relation to the above mentioned tables architecture. Whenever a new transaction 1010 arrives in the system, the system fetches the relevant Accounts and Agreements from the corresponding tables 1020. The Activity Type records for the corresponding Transaction are then selected 1030. Then, a loop for each selected Activity Type is opened 1040. Subsequently, another loop up to the Number of Repeats specified on the Activity Type is opened 1050. Then the predefined Activity Type Processing Script is executed 1060 while synchronizing with the G.L. Activities 1070 and inserting new Activities. Upon executing all the iterations of the loops 1040 and 1050, the Transaction status is updated to: ‘Processed’, ‘Partially Processed’ or ‘Failed to Process’ 1080 and the processing session ends 1090.

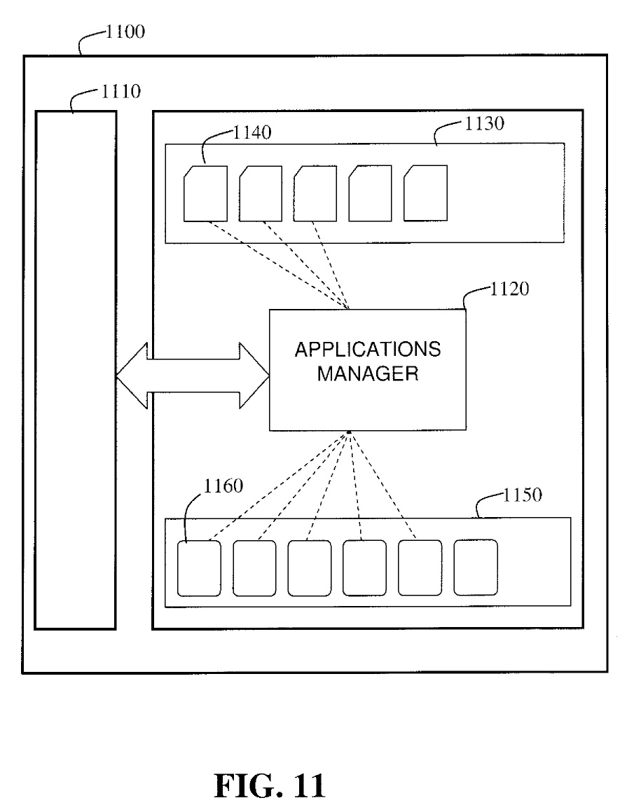

FIG. 11 is a block diagram showing in further details the structure of the Online Processing Platform (OPP) 1100. The OPP 1100 is essentially a Generic States Machine that is functioned to manage multiple online resources simultaneously. In Addition, it changes the path of processing while executing a transaction in order to adapt itself to the status of the environment at the point of execution. Thus, instead of tailoring processes and modules together using a fixed flow chart (like in other commercial resource tailoring packages) and relying on the programmers to think of each and every event that may happen during processing, the OPP 1100 does not require the programmer to think about each an every aspect of the process, and he or she can rely on the State Machine to adapt itself and change the processing path according to the situation on ground.

The OPP 1100 comprises a Connection Manager 1110 connected to an Application Manager 1120. It further includes a Processing Path Descriptors reservoir 1130 containing several Processing Path Descriptors 1140, and a Module Reservoir 1150, similarly containing several Modules 1160.

All online communications are conducted with the Connections Manager 1110 that manages the technical aspects of each connection. It is configurable to support the tweaks of various connection types. TCP/IP, SNA and other protocols are supported. The application protocol can be any protocol and it is converted internally to Extended ISO by a reformatting module started by the Applications Manager 1120.

The Applications Manager 1120 handles the request according to the Processing Path Descriptor 1140 that dynamically executes the transaction based on a generic states machine. The Processing Path Descriptors 1140 are stored on disk as XML files and are loaded to cache when the Online Processing Platform 1100 is started. In memory the Processing Path Descriptors 1140 are not stored in XML format, but rather in data classes organized in a structure in memory.

The Applications Manager 1120 starts and links with various Modules 1160 (internal such as Reformatting, Timeout, OR external such as VAP, and HSM). At any time, one of the modules man integrate with the Financial Products Engine if online billing is required.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description below.

It is to be understood that the terms “including”,“comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention, Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A system for generating a platform capable of processing and managing financial activities, said system comprising:
a financial products engine (FPE);
wherein said FPE comprises a financial products language compiler (FPLC) which is functioned to receive accounting-language oriented instructions and generate in turn billing processes; and wherein the billing processes are stored on a networked database as stored procedures.

2. The system according to claim 1, further comprising an online processing platform (OPP);
wherein said OPP receives transaction files and execute said billing processes generated by said FPE over said transaction files, wherein said execution results represent said financial activities performed in accordance with said financial instructions and definitions.

3. The system according to claim 2, wherein said FPE and said OPP are coupled to a networked database.

4. The system according to claim 3, wherein each said financial activity is managed in a double bookkeeping format.

5. The system according to claim 4 wherein said double bookkeeping format is achieved by, simultaneously updating, the relevant databases in regards to the relevant financial activities, financial instructions, financial transactions and definitions.

6. The system according to claim 5, wherein the OPP comprises:
a billing service module;
at least one batch management modules; and
an online management module;
wherein the billing service module is functioned to receive transaction files through the batch management module;
and wherein the billing service module is functioned to receive transaction files via the online management module for subsequent processing.

7. The system according to claim 6, wherein said financial instructions, definitions and transaction files are stored on said networked database in a tables architecture, and wherein each table holds information regarding the financial activity and is further related to other information regarding the financial activity.

8. The system according to claim 7, wherein said tables architecture supports said double bookkeeping format.

9. A method for generating a platform capable of processing and managing financial activities, said method comprising the steps of:
receiving accounting-language oriented instructions;
generating in turn corresponding billing processes;

10. The method according to claim 9, further comprising the steps of:
receiving transaction files to be managed;
matching the relevant transaction files with said executable billing processes corresponding to said financial rule and financial instruction in accordance with the various tables;
executing said billing processes over the corresponding transaction files.

11. The method according to claim 10, wherein receiving transaction files to be managed and matching the relevant transaction files comprises the steps of:
fetching the relevant information from the corresponding tables;
selecting an activity status for the records for the corresponding transaction.

12. The method according to claim 11, wherein executing said billing processes over the corresponding transaction files comprises the steps of:
executing predefined activity type processing script
synchronizing with the general ledger activities and inserting new financial activities.

13. A system for generating a platform capable of processing and managing financial activities, said system comprising:
means for receiving accounting-language oriented instructions;
means for generating in turn corresponding billing processes;

14. The system according to claim 13, further comprising:
means for receiving transaction files to be managed;
means for matching the relevant transaction files with said billing processes corresponding to said financial rule and financial instruction in accordance with the various tables;
means for executing said billing processes over the corresponding transaction files.

15. The system according to claim 14, wherein said means for receiving transaction files to be managed and said means for matching the relevant transaction files comprises:
means for fetching the relevant information from the corresponding tables;
means for selecting an activity status for the records for the corresponding transaction.

16. The system according to claim 15, wherein said means for executing said billing processes over the corresponding transaction files comprises:
means for executing predefined activity type processing script;
means for synchronizing with the general ledger activities and inserting new financial activities.
